(19) United States
(12) Patent Application Publication
(10) Pub. No.: US 2025/0366406 A1
(43) Pub. Date: Dec. 4, 2025

(54) COMPOSTABLE TAGS AND METHOD OF MANUFACTURING THEREOF

(71) Applicant: Multi Packaging Solutions, Inc., Atlanta, GA (US)

(72) Inventors: Michelle DIXON, Lansing, MI (US); Rick VULGAMOTT, Brighton, MI (US)

(21) Appl. No.: 18/876,119

(22) PCT Filed: Jun. 16, 2023
(86) PCT No.: PCT/US2023/025550

§ 371 Date: Dec. 17, 2024

Related U.S. Application Data
(60) Provisional application No. 63/353,261, filed on Jun. 17, 2022.

(51) Int. Cl. A01G 9/00

(52) U.S. Cl. CPC A01G 9/006

(57) ABSTRACT

A horticultural tag formed from a biodegradable, plant-based material, wherein the tag is free of a silicone surface treatment to facilitate printing on one or more sides of the tag. The tag may be adapted for hanging or attachment to a plant. The tag may also be adapted for at least partial insertion in soil surrounding a potted or planted plant.

### CROSS-REFERENCE TO RELATED APPLICATIONS

This application claims priority to and the benefit of U.S. Provisional Application No. 63/353,261, filed Jun. 17, 2022, the entire disclosure of which is incorporated by reference herein.

### FIELD

The present teachings generally relate to horticultural tags, and more particularly, to compostable horticultural tags.

### BACKGROUND

The horticultural industry often utilizes a variety of tags to help organize various plants, convey information to a consumer or retail establishment, or both. The tags may often provide information regarding a specific type of plant, care instructions for the identified plant, price information (if in a retail establishment), a barcode for scanning a retail establishment point-of-sale (POS), or a combination thereof. Similarly, if not within a retail establishment, the tags may help serialize plants during growth at an agricultural site. Often times, the tags are hung or otherwise secured to the plants directly. Similarly, the tags may also not be in direct contact with the plant, but rather inserted directly into the soil surrounding the plant.

Due to the tags often being located on or near plants outside, the tags are often required to be durable enough to withstand the elements, such as moisture, ultraviolet (UV) exposure (e.g., sun exposure), wind, or a combination thereof. As a result, the tags may be required to be manufactured using materials that are able to withstand the aforementioned elements without fracturing, breaking, or deteriorating for a desired amount of time. Similarly, the tags may be required to exhibit certain material characteristics, such as a desired stiffness (i.e., rigidity), durability at heightened or significantly lowered temperatures, moisture-resistance, UV-resistance, or a combination thereof. Even further, the tags may be required to have certain shapes to accommodate insertion into the ground, hanging, or both. Additionally, the tags may be required to function as a handle, in which the tag may provide a means for carrying a plant, a tray of plants, or both.

Due to these requirements, tags are often constrained to specific materials. For example, conventional horticultural tags may often utilize plastics, metals, or a combination thereof to ensure proper manufacturing of a desired shape while still being able to prevent material degradation. However, these conventional tags may not be environmentally friendly and may frequently require conventional disposal as waste without the ability to compost the tags.

Based on the above, there remains a need for a horticultural tag that provides an environmentally friendly alternative to conventional tags. What is needed is a horticultural tag that is made from a plant-based material. Similarly, there remains a need for a horticultural tag that is does not require waste disposal after use. What is needed is a horticultural tag that is made from industrial compostable materials and does not require waste disposal after use. Moreover, there remains a need for a horticultural tag made from environmentally friendly materials that meets industry demands for tag shapes, printing, or both. What is needed is a horticultural tag made from plant-based materials that still facilitate printing and shaping similar to a conventional horticultural tag.

### SUMMARY

The present teachings meet one or more of the present needs by providing a horticultural tag formed from a biodegradable, plant-based material, wherein the tag is free of a silicone surface treatment to facilitate printing on one or more sides of the tag.

The tag may include a denesting agent that allows for separation of the tag from additional tags. The plant-based material may include polylactic acid (PLA). The plant-based material may include poly(butylene adipate-co-terephthalate) (PBAT). The tag may be printed on both a first side and an opposing second side. The first side or the second side may include a matte finish. Additionally, the plant-based material may be corona treated to further facilitate printing on the one or more sides of the tag. The plant-based material may be free of any paper material. Moreover, the plant-based material may be free of metal. The plant-based material may be a plant-based plastic.

The tag may have a thickness of about 0.025 mm to about 1 mm. The tag may include a mineral additive to increases rigidity (e.g., stiffness), improve thermal behavior at heightened temperatures, or both. The mineral additive may be present in an amount of about 10% or less relative to a total weight of the tag. The mineral additive may be talc.

The tag may be die cut from a film. The tag may include one or more creases, perforations, one or more score lines, or a combination thereof.

The present teachings meet one or more of the present needs by providing a method of manufacturing a horticultural tag comprising: (a) forming the plant-based material into a film; (b) corona treating one or more surfaces of the film; (c) printing on the one or more surfaces of the film; and (d) cutting the film to form the tag. The method of manufacturing may be free of a silicone surface treatment.

The cutting of the film may be die cutting and the cutting may simultaneously form creases, score lines, perforations, or a combination thereof.

The present teachings may provide a tag adapted for hanging or attachment to a plant. The tag may be adapted for insertion into a slot of a slotted pot. The tag may also be adapted for at least partial insertion in soil surrounding a potted or planted plant.

The present teachings may also meet one or more of the present needs by providing: a horticultural tag that provides an environmentally friendly alternative to conventional tags; a horticultural tag that is made from a plant-based material; a horticultural tag that is does not require waste disposal after use; a horticultural tag that is made from industrially compostable materials and does not require waste disposal after use; a horticultural tag made from environmentally friendly materials that meets industry demands for tag shapes, printing, or both; a horticultural tag made from plant-based materials that still facilitate printing and shaping similar to a conventional horticultural tag; or a combination thereof.

### BRIEF DESCRIPTION OF THE DRAWINGS

FIG. 1A is a front view of a horticultural tag in accordance with the present teachings.

FIG. 1B is a front view of a horticultural tag in accordance with the present teachings.

FIG. 1C is a front view of a horticultural tag in accordance with the present teachings.

FIG. 1D is a front view of a horticultural tag in accordance with the present teachings.

FIG. 2 is a manufacturing process for the horticultural tag in accordance with the present teachings.

### DETAILED DESCRIPTION

The present teachings generally relate to a tag, and more specifically, a horticultural tag. However, it is envisioned that the tag as described herein may be implemented in various other industries other than horticulture, such as the food and beverage industry, construction industry, various consumer product industries, or a combination thereof. For example, while discussions herein may pertain to a tag related to a plant, the tag could also identify a location within a construction site, a food or beverage product, outdoor consumer products, or a combination thereof.

The tag may function to identify a plant. The tag may function to convey information about a particular plant. The tag may identify and/or convey information regarding a particular plant by securing the tag directly to the plant. For example, the tag may include a hanging feature or hanging mechanism that connects the tag to a stem of the plant, a leaf of the plan, or both. The hanging feature or hanging mechanism may include, but is not limited to, hooks, holes, projections, slits, or a combination thereof. For example, the tag may include an integrally (i.e., monolithically) formed hole or hook that connects to the plant directly. Additionally, the tag may be secured to the plant using an additional connection means. The additional connection means may be string, twine, a secondary hook, adhesive (e.g., tape), or a combination thereof that connect the tag to the plant.

In addition to securing the tag directly to the plant, it is also envisioned that the tag may be secured adjacent to the plant without direct contact to the plant. For example, the tag may be at least partially inserted into soil surrounding the plant. As a result, the tag may advantageously avoid any potential harm to the plant during attachment, yet still convey the desired information pertaining to the plant.

Due to utilization in the horticulture industry, the tag may be required to exhibit certain material properties. These material properties may correlate to environmental exposure to the tag when attached or indirectly connected to a plant (e.g., inserted into the ground). For example, the plants may frequently be stored or planted outside. As a result, an associated tag may also be exposed to the outdoors. Thus, the tag may be exposed to moisture and/or debris that could cause degradation to the tag. For example, snow, rain, watering of the plants, or a combination thereof may contact the tag and cause the tag to deteriorate.

Similarly, the tags may frequently be exposed to significant temperature fluctuations either outdoors or in interior growing environments. That is, the tag may be exposed to temperatures in the range of about −20° C. to about 60° C., about −10° C. to about 50° C., about 0° C. to about 40° C., or about 10° C. to about 30° C. Thus, it may be gleaned from the present teachings that the tag could be exposed to significantly colder or hotter temperatures when compared to an ambient temperature. As a result, the tag may be required to maintain structural integrity during such temperature fluctuations to avoid melting, brittleness, cracking, other deformation, or a combination thereof.

Even further, it is envisioned that the tag may beneficially provide additional material integrity. The tag may be corrosion resistant, anti-fungal, anti-bacterial, moisture wicking, ultraviolet (UV) resistant, chemical resistant, or a combination thereof. Therefore, based on the above, the tag as taught herein may prevent unwanted degradation when the tag is located outdoors, within soil, or both.

Advantageously, the tag as taught herein may not only exhibit the above characteristics but also provide an environmentally friendly alternative to conventional horticultural tags. That is, the tag may be compostable after use to decrease its carbon footprint and impact on the environment. Similarly, the tag may be biodegradable, compostable, or both after a desired duration of time as required by the horticulture industry.

To provide a fully compostable tag, it is envisioned that the tag is made from fully plant-based materials or other biological materials. The tag may about 50% plant-based or more, about 60% plant-based or more, or even 70% plant-based or more. The tag may be about 100% plant-based or less, about 90% plant-based or less, or about 80% plant-based or less. The composition of the material of the tags may be certified compostable per ASTM D6400, all of which is incorporated herein in its entirety for all purposes.

The tag may be made from a plant-based plastic or bioplastic. The plant-based plastic or bioplastic may be starch-based, cellulose-based, protein-based, or a combination thereof. The plant-based plastic or bioplastic may be biologically derived polyethylene, such as those produced from the fermentation of raw agricultural materials like sugarcane and/or corn. The plant-based plastic or bioplastic may be an aliphatic polyester.

The plant-based plastic or bioplastic material may be polylactic acid (PLA). The plant-based plastic or bioplastic may be poly(butylene adipate-co-terephthalate) (PBAT). The plant-based plastic or bioplastic may polyglycolic acid (PGA). The plant-based plastic or bioplastic may be poly-ε-caprolactone (PCL). The plant-based plastic or bioplastic may be polyhydroxybutyrate (PHB). The plant-based plastic or bioplastic may be poly(3-hydroxy valerate).

The plant-based plastic or bioplastic material may also be a combination of one or more plant-based plastics or bioplastics. That is, the tag may be made from a plurality of plant-based plastics or bioplastics such that the material may beneficially be tuned to meet one or more desired resultant product characteristics of the tag. For example, the tag may be made from PLA, PBAT, or a combination of both PLA and PBAT. The ratio of PLA to PBAT within the material composition may be about 1:1, about 2:1, about 3:1, about 1:2, or about 1:3. However, the ratio of PLA to PBAT may be any desired ratio based upon a given application and/or performance of the tag.

The PLA may be present in about 10% or more, about 25% or more, or about 50% or more of the total weight of the material composition of the tag. The PLA may be present in about 100% or less, about 75% or less, or about 60% or less of the total weight of the material composition of the tag.

The PBAT may be present in about 1% or more, about 5% or more, or about 10% or more of the total weight of the material composition of the tag. The PBAT may be present in about 30% or less, about 25% or less, or about 15% or less of the total weight of the material composition of the tag.

The material of the tag may also include one or more additives. However, it is envisioned that any additives within the material of the tag may also be environmentally friendly (e.g., compostable). Such additives may be incorporated into the material of the tag to further tune or modify material properties of the tag to meet industry demands. For example, the material of the tag may include one or more impact modifiers (e.g., core/shell material), one or more flame retardants, one or more fillers, one or more adhesives, one or more colorants, other modifiers, or a combination thereof. The modifiers may modify the material of the tag to ensure that the take is UV-resistant, anti-fungal, anti-microbial, water resistant and/or repellant, or a combination thereof.

Conventional tags may often utilize paper materials (e.g., paperboard), metals, or both to ensure feasibility of manufacturing of the tags. For example, the tags may frequently be die cut into a desired shape and the paper and/or materials utilized may ensure case of cutting without fractures or breaking of the cut tags. Similarly, conventional tags that utilize conventional plastics that are not bioplastics or plant-based plastics may often be brittle and unable to be die cut into a desired shape. However, to ensure that the horticulture tags are still environmentally friendly, the tags herein may not only utilize plant-based plastics or bioplastics but also be free of metals, paper materials, or both.

Advantageously, the present teachings may provide a tag material that may still exhibit the beneficial properties of a plastic yet may still be die cut and avoid the fallbacks of a conventionally brittle material. To exhibit such properties, the material of the tag may include one or more additives, such as a mineral-based additive, that aids in increasing stiffness (e.g., rigidity) of the plant-based plastic or bioplastic forming the tag. For example, the tag may be made from a combination of PLA and PBAT as a base material that may conventionally be flexible and unable to be die cut successfully. To ensure the proper rigidity or stiffness of the tag material, a mineral additive may be incorporated, thereby maintaining the benefit of more flexibility provided by the PLA and/or PBAT while also tuning the stiffness of the material to ensure consistent and proper die cutting of the material. Thus, it may be gleaned that the teachings herein provide for a highly tunable material.

As discussed above, a mineral additive may be incorporated into the material. The mineral additive may be in the form of a liquid, powder, pellets, resin, fibers, or a combination thereof. The mineral additive may be talc, calcium carbonate, silica, wollastonite, clay, calcium sulfate, mica, glass, alumina trihydrate, or a combination thereof. For example, the material of the tag may be a combination of PLA and PBAT that also includes a mineral additive of talc to increase rigidity (e.g., stiffness), improve thermal behavior at heightened temperatures (e.g., ensure structural integrity at higher temperatures), improve additional material characteristics, or a combination thereof.

It should also be noted that the tags may vary in color. While white tags may be conventional or often required in the horticulture industry, any desired color may be possible by incorporating one or more color additives into the material. These colors may include, but are not limited to, black, blue, yellow, green, purple, orange, red, pink, or a combination thereof. As such, the tags may be even further personalized for a specific application.

Conventional plastic materials, such as PLA, may often utilize a a surface treatment—such as a silicone treatment—to ensure proper material manufacturing, eliminate accidental adhesion of the material to itself, or both. For example, the silicone treatment may prevent caking of the material during manufacturing. However, the silicone may not be environmentally friendly, thereby even further increasing the carbon footprint of the material. To combat the use of surface treatments such as silicone, the present tag material may incorporate a denesting agent within the material (i.e., not a surface additive). The denesting agent may ensure formed tags do not adhere or otherwise stick to one another during manufacturing and/or packaging. The denesting agent may be incorporated as an additive into the material of the tag during manufacturing.

As mentioned above, the tag may convey information regarding a particular horticultural item, such as a plant, produce item (e.g., fruit, vegetable, etc.), or both. To convey such information, one or more surfaces of the tag may advantageously be printed directly onto without the need of secondary coatings or layers. Similarly, the tags may also be free of surface treatments such as the silicone treatment to maintain printability that may be found conventionally in other industries. For example, silicone surface treatments may be implemented in the food industry for plastic containers. However, the forming of the plastic containers may often include a heating step that burns off the silicone layer before printing. Similarly, many containers may maintain the silicone layer and not require printing at all.

In the present horticultural application, a heating step to burn off a surface layer may not be required due to corona treating the tag material prior to printing. During such corona treatment, the tag material may be electrolyzed to ensure proper adhesion of the ink to the tag material. As a result, the tag may be printed on one or more sides with any number of colors, yet still eliminate the need for non-environmentally friendly materials (e.g., silicone and/or ink adhesion primers). Advantageously, the step of corona treating during the manufacturing process of the material of the tag may eliminate the excess cost and time of additional coating layers such as the silicone. Additionally, the addition of the aforementioned denesting agent may maintain benefits of the silicone coating while still maintaining printability of the tag.

To even further provide tunability of the tag, one or more surfaces of the tag may have a specified surface finish. The specified finish may be free of a secondary coating (e.g., a silicone surface treatment), yet still provide tunability of surfaces of the tag. One or more surfaces of the tag may have a matte finish, a semi-gloss finish, a shiny finish, or a combination thereof. It should be noted that within the aforementioned finish categories there may be even further modification to change the degree of a finish (e.g., one or more levels of semi-gloss finish). Beneficially, the one or more surfaces of the tag may be modified for a specific surface finish yet still maintain printability.

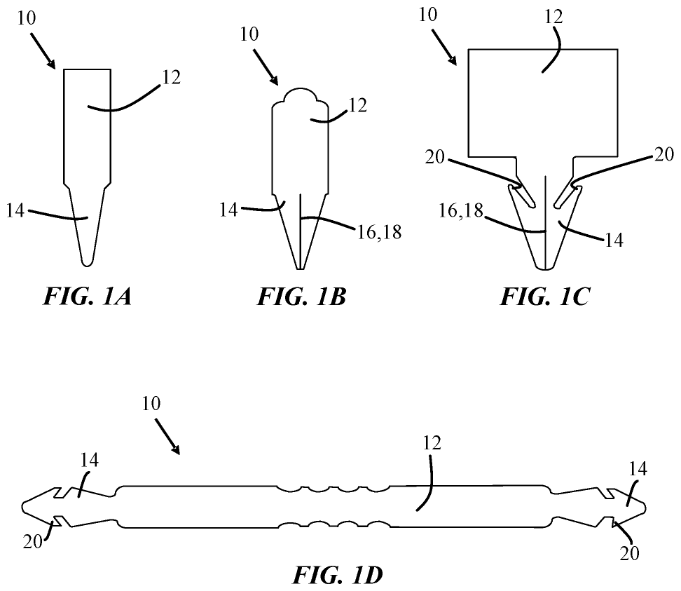

Turning now to the figures, FIG. 1A-1D illustrate various exemplary horticultural tags 10. The tags 10 may include a body 12. The body 12 may be a region of the tag 10 in which printing is completed. The printing may be text, images (e.g., pictures, QR codes, etc.), or both to convey the desired information about an associated plant. Furthermore, as discussed above, the printing may be completed in any color based upon a selected color of the tag 10. The body 12 may also be intended as a visual portion of the tag 10 that remains unobstructed when secured to or near the associated plant. In certain, configurations, such as the tag 10 shown in FIG. 1D, the body 12 of the tag 10 may also be configured as a handle that may facilitate carrying of a plant or packaging of one or more plants (e.g., a plant tray).

As shown in FIGS. 1A-1D, the tag 10 also includes an insertion portion 14. The insertion portion 14 may be configured for insertion into soil or other substrates in which the plant is inserted (e.g., packaging materials) to be positioned substantially near the associated plant. The insertion portion 14 may be configured for insertion into a slot (e.g., a slotted pot of a plant). As such, the insertion portion may be adapted for both downward insertion (e.g., insertion downward into soil or other substrates so that the body 12 may be supported by the insertion portion 14 within the soil or other substrate) and upward insertion (e.g., insertion upward into a slot or other substrate so that the body 12 of the tag 10 hangs from the insertion portion 14). The insertion portion 14 may vary in size and/or shape to facilitate ease of insertion into the soil or other substrates. It should be noted that printing may also be completed on the insertion portion 14. However, it is envisioned that the printing on the body 12 remains unobstructed while the printing on the insertion portion 14 may be unviewable after attachment or securing of the tag 10.

A transition region may be present between the body 12 and the insertion portion 14. For example, a step, notch, groove, cutout, contour, or a combination thereof may define a connecting region between the body 12 and the insertion portion 14. Thus, it may be gleaned from the present teachings that various shapes and features may be incorporated into the tag 10.

Similarly, as discussed above, one or more surfaces of the tag 10 formed from the body 12, the insertion portion 14, or both, may include a surface finish. For example, FIGS. 1A-1C may illustrate a first side of the tag 10 while a second opposing side is not shown. The first side of the tag 10 may have a matte finish while the opposing second side may have a semi-gloss or gloss finish. However, printing may still be completed on one or both sides of the tag 10 along the body 12, the insertion portion 14, or both regardless of the surface finish present.

The insertion portion 14 may also include one or more additional features that aid with insertion or attachment of the tag 10, help maintain structural integrity of the tag 10, help maintain positioning of the tag 10 once inserted or attached, or a combination thereof. The additional features may include one or more perforations 16, one or more score lines 18, or both. The perforations 16 and/or score lines 18 may extend anywhere along the tag 10 (i.e., the body 12 and/or the insertion portion 14) in any desired direction at a selected length. For example, as shown in FIG. 1B, the perforation 16 or score line 18 may extend to a distal tip of the insertion portion 14 up until a connecting region between the insertion portion 14 and the body 12.

The additional features located on the insertion portion 14 may also include one or more cutouts 20. The cutouts 20 may provide retention means for the insertion portion 14 after the insertion portion 14 is inserted into the soil or substrate retaining the plant. For example, the cutouts 20 may form one or more teeth, projections, fins, or a combination thereof that retain the insertion portion 14 in the ground or substrate. Additionally, an angle of the formed teeth, projections, fins, or a combination thereof may allow for easy insertion into the ground or substrate yet oppose a removal direction of the insertion portion 14.

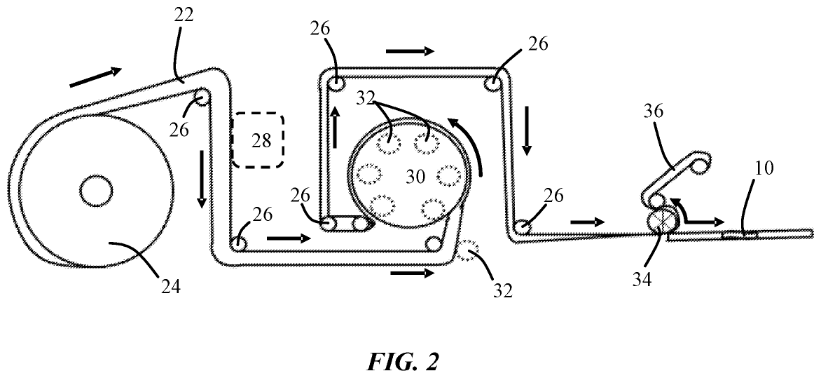

FIG. 2 illustrates a manufacturing process of a horticultural tag 10 in accordance with the present teachings. It is envisioned that one or a plurality of tags 10 may be formed from a film 22. Such a film 22 may be formed from the one or more materials discussed above (e.g., PLA, PBAT, additives, etc.). The film 22 may be inserted into the manufacturing process on a material feed 24. As a result, the film 22 may be provided as a roll or sheet in varying dimensions. That is, depending on the desired resultant tag 10, the film 22 may vary in thickness, width, length, or a combination thereof. For example, the film 22 may have varying thicknesses for certain applications to ensure proper structural integrity of the formed tags 10.

The thickness of the film 22 may be about 0.1 mm or more, about 0.5 mm or more, or about 1 mm or more. The thickness of the film 22 may be about 2 mm or less, about 1.75 mm or less, or about 1.25 mm or less.

A width of the film 22 may be about 10 cm or more, about 25 cm or more, or about 50 cm or more. A width of the film 22 may be about 100 cm or less, about 75 cm or less, or about 60 cm or less.

Once a roll or sheet of film 22 is inserted into the material feed 24, the film 22 may be moved along the manufacturing process by one or more rollers 26. However, it should be noted that any means of movement may be utilized to advance the film 22 along the manufacturing process.

The film 22 may initially be advanced through a corona treater 28. The corona treater 28 may be adapted to impart changes in surface properties of the film 22. The corona treater 28 discharge plasma or otherwise electrolyze one or more surfaces of the film 22. As a result, the corona treater 28 may advantageously facilitate better adhesion of printing onto one or more surfaces of the film 22 without the need of a secondary surface coating prior to printing by ensuring minimum dyne levels of the film 22. Thus, the corona treater 28 may at least in part aid in maintaining an eco-friendly material for the tags 10.

After exposure to the corona treater 28, the film 22 may advance through a printing press 30 having one or more printing stations 32. The printing stations 32 may be adapted to print images, text, or both. The printing stations 32 may print in any desired color directly onto the film 22. That is, the film 22 may be primed prior to printing at the printing stations 32 but does not need to be primed. The printing stations 32 may print one or more both sides of the film 22. For example, a subset of the printing stations 32 may print a back side of the film 22 while a second subset of the printing stations 32 may print a front side of the film 22. As a result, printing of the front side and the back side of the film 22 may be done concurrently (e.g., back side is printed first than the front side is printed, or vice versa), simultaneously, or both. Furthermore, as discussed above, the front side and/or back side may include a surface finish (e.g., gloss, matte, etc.) that is printed directly onto at the printing stations 32.

Once printing within the printing press 30 is complete, the film 22 is further advanced by the rollers as indicated by the arrows illustrated in FIG. 2. The film 22 is moved into a die cutter 34, whereby the desired horticultural tags 10 are cut out of the film 22. It should be noted that the die cutter 34 may advantageously cut the profile of the tags 10 while simultaneously cutting any score lines, perforations, cutouts, or a combination thereof (see FIGS. 1A-IC).

Moreover, the die cutter 34 may beneficially form the profiles and any secondary features of the tags 10 while still maintaining a sheet of interconnected tags 10. For example, a profile of the tags 10 may be substantially or entirely cut by the die cutter 34, yet one or more portions of the film (e.g., nicks, perforations, etc.) may interconnect the formed tags 10 so case movement of the tags 10 downstream for any finishing operations. Such finishing operations (not shown) may include bundling of the tags 10, packaging of the tags 10, shipment of the tags 10, or a combination thereof. At such finishing operations, the tags 10 may be easily separated for final finishing steps.

It should be noted that the above-mentioned manufacturing process is free of a baking stage. That is, a surface treatment to denest conventional PLA materials (e.g., a silicone treatment) is not present on the tags 10. Such a treatment may conventionally be required to burn off prior to printing on the material. In this case, the film 22 includes an internal denesting agent that facilitates easy packaging, stacking, or both of the tags 10 once finished without the need of a secondary surface treatment. As a result, the tags 10 may beneficially remove an extra step during manufacturing while also allowing for stacking of the tags after burn off, printing, or both.

Additionally, during cutting of the tags 10, a matrix 36 may reel or otherwise wind cut scraps from the die cutter 34. This material may then be distributed to another location for repurposing, composting, or both. It should also be noted that in certain circumstances, the material or scrapped tags 10 may also be recyclable.

### ELEMENT LIST

10 Tag
12 Body
14 Insertion Portion
16 Perforation
18 Score Line
20 Cutout
22 Film
24 Material Feed
26 Roller
28 Corona Treater
30 Printing Press
32 Printing Station
34 Die Cutter
36 Matrix

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference herein in their entirety for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference herein in their entirety for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A horticultural tag formed from a biodegradable, plant-based material, wherein the tag is free of a silicone surface treatment to facilitate printing on one or more sides of the tag.

2. The horticultural tag of claim 1, wherein the tag includes a denesting agent that allows for separation of the tag from additional tags.

3. The horticultural tag of claim 1 or claim 2, wherein the plant-based material includes polylactic acid (PLA).

4. The horticultural tag of any of the preceding claims, wherein the plant-based material includes poly(butylene adipate-co-terephthalate) (PBAT).

5. The horticultural tag of any of the preceding claims, wherein the tag is printed on both a first side and an opposing second side.

6. The horticultural tag of claim 5, wherein the first side or the second side includes a matte finish.

7. The horticultural tag of any of the preceding claims, wherein the plant-based material is corona treated to further facilitate printing on the one or more sides of the tag.

8. The horticultural tag of any of the preceding claims, wherein the tag has a thickness of about 0.25 mm to about 1 mm.

9. The horticultural tag of any of the preceding claims, wherein the plant-based material is free of any paper material.

10. The horticultural tag of any of the preceding claims, wherein the plant-based material is free of metal.

11. The horticultural tag of any of the preceding claims, wherein the tag includes a mineral additive to increases rigidity (e.g., stiffness), improve thermal behavior at heightened temperatures, or both.

12. The horticultural tag of claim 11, wherein the mineral additive is present in an amount of about 10% or less relative to a total weight of the tag.

13. The horticultural tag of claim 11 or 12, wherein the mineral additive is talc.

14. The horticultural tag of any of the preceding claims, wherein the tag is die cut from a film.

15. The horticultural tag of any of the preceding claims, wherein the plant-based material is a plant-based plastic.

16. The horticultural tag of any of the preceding claims, wherein the tag includes one or more creases, perforations, one or more score lines, or a combination thereof.

17. A method of manufacturing the horticultural tag of any of the preceding claims, comprising:
(a) forming the plant-based material into a film;
(b) corona treating one or more surfaces of the film;
(c) printing on the one or more surfaces of the film; and
(d) cutting the film to form the tag,
wherein the method of manufacturing is free of a silicone surface treatment.

18. The method of claim 17, wherein a plurality of tags are cut from the film and the plurality of tags are stacked on top of each other for storage or shipping.

19. The method of claim 17 or 18, wherein the cutting of the film is die cutting, and the cutting simultaneously forms creases, score lines, perforations, or a combination thereof.

20. The horticultural tag of any of the preceding claims, wherein the tag is adapted for hanging or attachment to a plant.

21. The horticultural tag of any of the preceding claims, wherein the tag is adapted for at least partial insertion into soil surrounding a potted or planted plant.
